(19) United States
(12) Patent Application Publication
(10) Pub. No.: US 2013/0229425 A1
(43) Pub. Date: Sep. 5, 2013

(54) IMAGE PROCESSING METHOD AND ASSOCIATED APPARATUS

(71) Applicant: MSTAR SEMICONDUCTOR, INC., Hsinchu Hsien (TW)

(72) Inventors: Ren-Kuan Liang, Taichung City (TW); Wen-Chih Liu, Hsinchu Hsien (TW)

(73) Assignee: MSTAR SEMICONDUCTOR, INC., Hsinchu Hsien (TW)

(21) Appl. No.: 13/740,488

(22) Filed: Jan. 14, 2013

(30) Foreign Application Priority Data
Mar. 3, 2012 (TW) 101107236

(51) Int. Cl. G09G 3/36

(52) U.S. Cl. CPC G09G 3/36
USPC 345/545

(57) ABSTRACT

An image processing apparatus includes a memory, a processing unit and an overdriving unit. The memory stores a data-truncated previous frame. The processing unit performs edge detection on the previous frame, and performs an image smoothing process according to an edge detection result to generate a processed previous frame. The overdriving unit performs an overdriving process according to the processed previous frame and a current frame to generate an output frame.

This application claims the benefit of Taiwan application Serial No. 101107236, filed Mar. 3, 2012, the subject matter of which is incorporated herein by reference.

### BACKGROUND OF THE INVENTION

1. Field of the Invention

The invention relates in general to image processing, and more particularly to an image processing apparatus and associated method applied to a liquid crystal overdrive technique.

2. Description of the Related Art

An overdrive technique is prevalent in current liquid crystal displays (LCD) for enhancing a response speed of liquid crystal molecules. In the overdrive technique, an overdrive process is performed according to a previous frame and a current frame to obtain a corresponding overdrive voltage for driving liquid crystal molecules. Therefore, data of the previous frame needs to be temporarily stored in a memory when applying the overdrive technique.

To minimize a usage amount of the memory, data of the previous frame is truncated before being stored into the memory. For example, assuming each pixel in the previous frame contains 8 bits of data, but only data of 4 most significant bits out of the 8 bits is stored into the memory. Thus, information on image details of the previous frame is lost due to the truncated data of the previous frame stored in the memory. For example, due to the lost data of the least significant bits, an original continuous grayscale gradient appears as a discontinuous gradient. In other words, the overdrive technique has a tendency of downgrading the quality of an output frame by sacrificing details of a previous frame.

### SUMMARY OF THE INVENTION

The invention is directed to a solution for mitigating and eliminating the foregoing issue of an unsatisfactory quality of an output frame caused by reduced memory usage amount in the overdrive technique.

According to an aspect the present invention, an image processing apparatus is provided. The apparatus comprises a memory, a processing unit and an overdriving unit. The memory stores a data-truncated previous frame. The processing unit performs an image smoothing process on the previous frame. The overdriving unit performs an overdriving process according to the processed previous frame and a current frame to generate an output frame.

According to another aspect of the present invention, an image processing method, applied to an image processing apparatus, is provided. The method comprises steps of: storing a data-truncated previous frame; performing an image smoothing process on the previous frame; and performing an overdriving process according to the processed previous frame and a current frame to generate an output frame.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of an image processing apparatus according to one embodiment of the present invention.

FIG. 2 is a flowchart of an image processing method according to one embodiment of the present invention.

FIG. 3 is a block diagram of processing unit according to one embodiment of the present invention.

FIG. 4 is a detailed flowchart of Step 22.

FIG. 5 is a schematic diagram of partial pixels of a previous frame F(n−1)[7:4].

### DETAILED DESCRIPTION OF THE INVENTION

To eliminate a discontinuous gradient caused by truncated data, an image processing apparatus and associated method is provided by an embodiment below. The image processing apparatus according to an embodiment of the present invention comprises a memory, a processing unit and an overdriving unit. The memory stores a previous frame, which is data-truncated before being stored into the memory. The processing unit performs edge detection on the previous frame, and performs an image smoothing process on the previous frame according to an edge detection result. The overdriving unit performs an overdriving process according to the processed previous frame and a current frame to generate an output frame.

The image processing method according to an embodiment of the present invention comprises steps of: storing a previous frame into a memory, the previous frame being data-truncated before being stored into the memory; performing edge detection on the previous frame, and performing an image smoothing process on the previous frame according to an edge detection result; and performing an overdriving process according to the processed previous frame and a current frame to generate an output frame.

In one embodiment, the processing unit of the present invention comprises an edge detecting unit, a coefficient selecting unit and a low-pass filter. The edge detecting unit performs edge detection on a target block in a plurality of blocks of the data-truncated previous frame to generate the edge detection result. The coefficient selecting unit determines a set of filter coefficients according to the edge detection result. The low-pass filter performs the image smoothing process according to the set of filter coefficients to repair the truncated data of the previous frame.

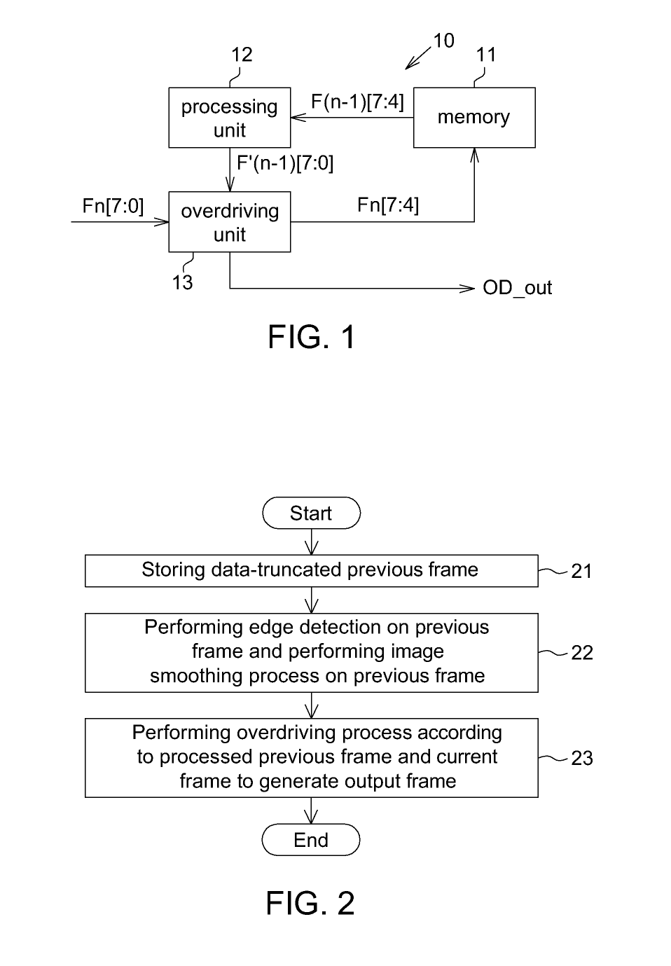

Referring to FIGS. 1 and 2, FIG. 1 shows a block diagram of an image processing apparatus according to one embodiment of the present invention; FIG. 2 shows a flowchart of an image processing method according to one embodiment of the present invention. An image processing apparatus 10 comprises a memory 11, a processing unit 12 and an overdriving unit 13. For exemplary and illustrative purposes, in the following description, a previous frame is expressed as F(n−1)[7:4], a current frame is expressed as F(n)[7:0], and a processed previous frame is expressed as F′(n−1)[7:0]. [7:0] represents data comprising bits 7 to 0, and [7:4] represents data comprising bits 7 to 4. Therefore, the previous frame F(n−1)[7:4] indicates that data from bit 3 to bit 0 is truncated.

The image processing method is applicable to the image processing apparatus 10, and comprises the following steps. In Step 21, the memory 11 stores the previous frame F(n−1)[7:4], which contains only data of bit 7 to bit 4 of each pixel. That is to say, data of bit 3 to bit 0 in each pixel in the previous frame F(n−1) is truncated. In Step 22, the processing unit 12 performs edge detection on the previous frame F(n−1)[7:4], and performs an image smoothing process on the previous frame F(n−1)[7:4] according to an edge detection result to repair the truncated data of the previous frame. Accordingly, each pixel in the processed previous frame F′(n−1)[7:0] is provided with complete 8 bits of data. In Step 23, the overdriving unit 13 performs an overdriving process according to the repaired previous frame F′(n−1)[7:0] and the current frame F(n)[7:0] to generate an output frame OD_out.

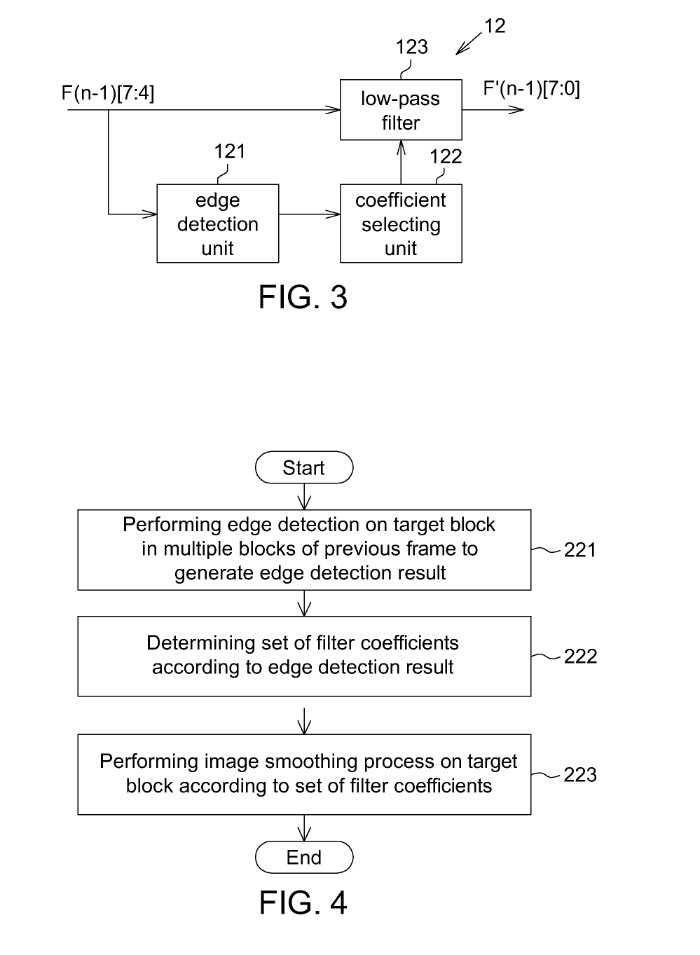

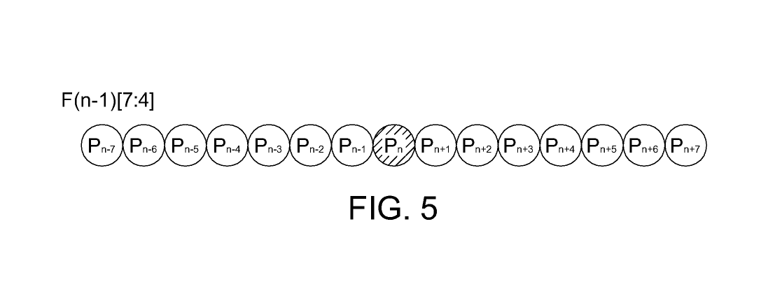

Referring to FIGS. 3, 4 and 5, FIG. 3 shows a block diagram of a processing unit according to an embodiment of the present invention; FIG. 4 shows a detailed flowchart of Step 22 according to an embodiment of the present invention; FIG. 5 shows a schematic diagram of partial pixels in the previous frame F(n−1)[7:4]. The processing unit 12 further comprises an edge detecting unit 121, a coefficient selecting unit 122 and a low-pass filter 123. Step 22 further comprises Steps 221 to 223. In Step 221, the edge detecting unit 121 performs edge detection on a target block in a plurality of blocks of the previous frame F(n−1)[7:4] to generate the edge detection result. For example, edge detection comprises determining whether a neighboring pixel difference in the target block is not greater than a threshold. When the neighboring pixel difference is not greater than the threshold, the neighboring pixel difference does not correspond to an image edge of the previous frame F(n−1)[7:4]. Conversely, when the neighboring pixel difference is greater than the threshold, it means the target block corresponds to an image edge of the previous frame F(n−1)[7:4]. That is, the image edge is a real edge and is not a discontinuous gradient caused by the truncated data. Thus, the real edges of the target block do not need to be image smoothing processed by the low-pass filter 123. In other words, the low-pass filter 123 only processes the discontinuous gradient caused by the truncated image data. The foregoing threshold may correspond to a least significant bit of the previous frame F(n−1)[7:4]. For example, the number of the least significant bit is 1 bit.

In Step 222, the coefficient selecting unit 122 determines a set of filter coefficients according to the edge detection result. More specifically, the coefficient selecting unit 122 determines a pixel value distribution of the target block according to the edge detection result, so as to determine a filter interval from the target block and a set of filter coefficients. The coefficient selecting unit 122 further determines whether the pixel value distribution detected in the interval is monotonically increasing or monotonically decreasing. When the pixel value distribution is concurrently increasing and decreasing, it means the interval contains real image edges. Thus, by determining whether the pixel value distribution is monotonically increasing or monotonically decreasing, the coefficient selecting unit 122 identifies the discontinuous gradient caused by the truncated image data in the previous frame F(n−1)[7:4].

A coefficient sum of the set of filter coefficients corresponds to a ratio of a grayscale resolution of the current frame F(n)[7:0] and a grayscale resolution of the previous frame F(n−1)[7:4]. More specifically, the current frame F(n)[7:0] has a grayscale resolution of 256 by having 8 bits of data, whereas the previous frame F(n−1)[7:4] has a grayscale resolution of 16 by having only 4 bits of data. Thus, the grayscale resolution ratio of the current frame F(n)[7:0] and the previous frame F(n−1)[7:4] is 16, and so the sum of each set of filter coefficients corresponds to 16. In fact, the grayscale resolution ratio of the current frame F(n)[7:0] and the previous frame F(n−1)[7:4] equals the grayscale resolution of the truncated data of the previous frame. In this embodiment, the previous frame is truncated by 4 bits of data, which represents 16 levels of grayscale. It is concluded that the sum of each set of filter coefficients is physically determined by the bit count of the truncated data of the previous frame. In Step 223, the low-pass filter 223 performs the image smoothing process on the target block according to the set of filter coefficients to eliminate the discontinuous gradient and to repair the data of the previous frame F(n−1)[7:4].

For example, the target block includes pixels Pₙ₋₇ to Pₙ₊₇. The coefficient selecting unit 122 determines the pixel value distribution of the pixels Pₙ₋₁ to Pₙ₊₇ of the target block according to the edge detection result to accordingly determine a filter interval from the target block and a set of filter coefficients. When performing Step 221, the edge detecting unit 121 subtracts a pixel value of every two neighboring pixels from the other in the pixels Pₙ₋₇ to Pₙ₊₇ to respectively obtain a pixel difference. The pixel differences may be represented by pixel differences Dₙ₋₆ to Dₙ₊₇. For example, the pixel difference Dₙ₋₆ equals the pixel value Pₙ₋₅ subtracted from Pₙ₋₆, the pixel difference Dₙ₊₇ equals the pixel value Pₙ₊₆ subtracted from Pₙ₊₇, and so forth.

The coefficient selecting unit 122 determines whether the pixel value distribution of the pixels Pₙ₋₇ to Pₙ₊₇ is monotonically increasing or monotonically decreasing according to the pixel differences Dₙ₋₆ to Dₙ₊₇, and determines whether an absolute value of the pixel difference between the pixel Pₙ₊₇ and the pixel Pₙ₋₇ is not greater than a threshold. The pixel difference between the pixel Pₙ₊₇ and the pixel Pₙ₋₇ is the foregoing neighboring pixel difference. When the pixel value distribution of the pixels Pₙ₋₇ to Pₙ₊₇ is monotonically increasing or monotonically decreasing and the neighboring pixel difference between the pixel Pₙ₊₇ and the pixel Pₙ₋₇ is not greater than the threshold, the coefficient selecting unit 122 selects a corresponding set of filter coefficients Coef=[1 1 1 1 1 1 1 2 1 1 1 1 1 1 1]. The coefficient selecting unit 122 further determines that the filter interval is 15 taps. After determining the filter coefficients and the filter interval, the low-pass filter 223 generates a pixel value of a target pixel in the target interval according to the set of filter coefficients and the pixel values of the pixels in the filter interval. In this example, the low-pass filter 223 generates the pixel value of a target pixel according to the pixel values of 15 pixels in the filter interval and the corresponding filter coefficients. For example, the target pixel is a middle pixel in the filter interval.

Conversely, when the pixel value distribution of the pixels Pₙ₋₇ to Pₙ₊₇ is not monotonically increasing or monotonically decreasing, or when the neighboring pixel difference between the pixels Pₙ₋₇ and Pₙ₊₇ is greater than the threshold, the coefficient selecting unit 122 decreases the filter interval.

The coefficient selecting unit 122 then determines whether the pixel value distribution of the pixels Pₙ₋₆ to Pₙ₊₆ is monotonically increasing or monotonically decreasing according to the pixel differences Dₙ₋₅ to Dₙ₊₆, and determines whether the neighboring pixel difference between the pixels Pₙ₋₆ and Pₙ₊₆ is not greater than a threshold. When the pixel value distribution of the pixels Pₙ₋₆ to Pₙ₊₆ is monotonically increasing or monotonically decreasing and the neighboring pixel difference between the pixels Pₙ₋₆ and Pₙ₊₆ is not greater than the threshold, the coefficient selecting unit 122 selects a corresponding set of filter coefficients Coef=[0 1 1 1 1 1 2 2 2 1 1 1 1 1 0]. The coefficient selecting unit 122 further changes the filter interval from 15 taps to 13 taps.

Conversely, when the pixel value distribution of the pixels Pₙ₋₆ to Pₙ₊₆ is not monotonically increasing or monotonically decreasing, or when the neighboring pixel difference between the pixels Pₙ₋₆ and Pₙ₊₆ is greater than the threshold, the coefficient selecting unit 122 determines whether the pixel value distribution of the pixels Pₙ₋₅ to Pₙ₊₅ is monotonically increasing or monotonically decreasing according to the pixel differences Dₙ₋₄ to Dₙ₊₅, and determines whether the neighboring pixel difference between the pixels Pₙ₋₅ and Pₙ₊₅ is not greater than a threshold. When the pixel value distribution of the pixels Pₙ₋₅ to Pₙ₊₅ is monotonically increasing or monotonically decreasing and the neighboring pixel difference between the pixels Pₙ₋₅ and Pₙ₊₅ is not greater than the threshold, the coefficient selecting unit 122 selects a corresponding set of filter coefficients Coef=[0 0 1 1 1 2 2 2 2 2 1 1 1 0 0]. The coefficient selecting unit 122 further changes the filter interval from 13 taps to 11 taps.

Conversely, when the pixel value distribution of the pixels Pₙ₋₅ to Pₙ₊₅ is not monotonically increasing or monotonically decreasing, or when the neighboring pixel difference between the pixels Pₙ₋₅ and Pₙ₊₅ is greater than the threshold, the coefficient selecting unit 122 determines whether the pixel value distribution of the pixels Pₙ₋₄ to Pₙ₊₄ is monotonically increasing or monotonically decreasing according to the pixel differences Dₙ₋₃ to Dₙ₊₄, and determines whether the neighboring pixel difference between the pixels Pₙ₋₄ and Pₙ₊₄ is not greater than a threshold. When the pixel value distribution of the pixels Pₙ₋₄ to Pₙ₊₄ is monotonically increasing or monotonically decreasing and the neighboring pixel difference between the pixels Pₙ₋₄ and Pₙ₊₄ is not greater than the threshold, the coefficient selecting unit 122 selects a corresponding set of filter coefficients Coef=[0 0 0 1 2 2 2 2 2 2 2 1 0 0 0]. The coefficient selecting unit 122 further changes the filter interval from 11 taps to 9 taps.

Conversely, when the pixel value distribution of the pixels Pₙ₋₄ to Pₙ₊₄ is not monotonically increasing or monotonically decreasing, or when the neighboring pixel difference between the pixels Pₙ₋₄ and Pₙ₊₄ is greater than the threshold, the coefficient selecting unit 122 determines whether the pixel value distribution of the pixels Pₙ₋₃ to Pₙ₊₃ is monotonically increasing or monotonically decreasing according to the pixel differences Dₙ₋₂ to Dₙ₊₃, and determines whether the neighboring pixel difference between the pixels Pₙ₋₃ and Pₙ₊₃ is not greater than a threshold. When the pixel value distribution of the pixels Pₙ₋₃ to Pₙ₊₃ is monotonically increasing or monotonically decreasing and the neighboring pixel difference between the pixels Pₙ₋₃ and Pₙ₊₃ is not greater than the threshold, the coefficient selecting unit 122 selects a corresponding set of filter coefficients Coef=[0 0 0 0 2 2 2 4 2 2 2 0 0 0 0]. The coefficient selecting unit 122 further changes the filter interval from 9 taps to 7 taps.

Conversely, when the pixel value distribution of the pixels Pₙ₋₃ to Pₙ₊₃ is not monotonically increasing or monotonically decreasing, or when the neighboring pixel difference between the pixels Pₙ₋₃ and Pₙ₊₃ is greater than the threshold, the coefficient selecting unit 122 determines whether the pixel value distribution of the pixels Pₙ₋₂ to Pₙ₊₂ is monotonically increasing or monotonically decreasing according to the pixel differences Dₙ₋₁ to Dₙ₊₂, and determines whether the neighboring pixel difference between the pixels Pₙ₋₂ and Pₙ₊₂ is not greater than a threshold. When the pixel value distribution of the pixels Pₙ₋₂ to Pₙ₊₂ is monotonically increasing or monotonically decreasing and the neighboring pixel difference between the pixels Pₙ₋₂ and Pₙ₊₂ is not greater than the threshold, the coefficient selecting unit 122 selects a corresponding set of filter coefficients Coef=[0 0 0 0 0 2 4 4 4 2 0 0 0 0 0]. The coefficient selecting unit 122 further changes the filter interval from 7 taps to 5 taps.

Conversely, when the pixel value distribution of the pixels Pₙ₋₂ to Pₙ₊₂ is not monotonically increasing or monotonically decreasing, or when the neighboring pixel difference between the pixels Pₙ₋₂ and Pₙ₊₂ is greater than the threshold, the coefficient selecting unit 122 determines whether the pixel value distribution of the pixels Pₙ₋₁ to Pₙ₊₁ is monotonically increasing or monotonically decreasing according to the pixel differences Dₙ to Dₙ₊₁, and determines whether the neighboring pixel difference between the pixels Pₙ₋₁ and Pₙ₊₁ is not greater than a threshold. When the pixel value distribution of the pixels Pₙ₋₁ to Pₙ₊₁ is monotonically increasing or monotonically decreasing and the neighboring pixel difference between the pixels Pₙ₋₁ and Pₙ₊₁ is not greater than the threshold, the coefficient selecting unit 122 selects a corresponding set of filter coefficients Coef=[0 0 0 0 0 0 4 8 4 0 0 0 0 0 0]. The coefficient selecting unit 122 further changes the filter interval from 5 taps to 3 taps.

Conversely, when the pixel value distribution of the pixels Pₙ₋₁ to Pₙ₊₁ is not monotonically increasing or monotonically decreasing, or when the neighboring pixel difference between the pixels Pₙ₋₁ and Pₙ₊₁ is greater than the threshold, the coefficient selecting unit 122 selects a corresponding set of filter coefficients Coef=[0 0 0 0 0 0 0 16 0 0 0 0 0 0 0]. The coefficient selecting unit 122 further changes the filter interval from 3 taps to 1 tap. When the coefficient selecting unit 122 selects the set of filter coefficients Coef=[0 0 0 0 0 0 0 16 0 0 0 0 0 0 0], it means the low-pass filter 123 does not perform low-pass filter.

The above examples can be implemented by a processor executing the code below:

Dn=Pn−Pn−1

### If {(((Dn−6˜Dn+7)>=0 or ((Dn−6˜Dn+7)<=0))&(abs(Pn+7-Pn−7)<=1))}

Coef=[1 1 1 1 1 1 1 2 1 1 1 1 1 1 1]

else if {(((Dn−5˜Dn+6)>=0 or ((Dn−5˜Dn+6)<=0))&abs(Pn+6-Pn−6)<=1))}

Coef=[0 1 1 1 1 1 2 2 2 1 1 1 1 1 0]

else if {(((Dn−4˜Dn+5)>=0 or ((Dn−4˜Dn+5)<=0))&(abs(Pn+5-Pn−5)<=1))}

Coef=[0 0 1 1 1 2 2 2 2 2 1 1 1 0 0]

else if {(((Dn−3˜Dn+4)>=0 or ((Dn−3˜Dn+4)<=0))&(abs(Pn+4-Pn−4)<=1))}

Coef=[0 0 0 1 2 2 2 2 2 2 2 1 0 0 0]

else if {(((Dn−2˜Dn+3)>=0 or ((Dn−2˜Dn+3)<=0))&(abs(Pn+3-Pn−3)<=1))}

Coef=[0 0 0 0 2 2 2 4 2 2 2 0 0 0 0]

else if {(((Dn−1˜Dn+2)>=0 or ((Dn−1˜Dn+2)<=0))&(abs(Pn+2-Pn−2)<=1))}

Coef=[0 0 0 0 0 2 4 4 4 2 0 0 0 0 0]

else if {(((Dn˜Dn+1)>=0 or ((Dn˜Dn+1)<=0))&(abs(Pn+1-Pn−1)<=1))}

Coef=[0 0 0 0 0 0 4 8 4 0 0 0 0 0 0]

else Coef=[0 0 0 0 0 0 0 16 0 0 0 0 0 0 0]

With the above description of the embodiment, it is illustrated that the image processing apparatus and the image processing method of the present invention are capable of eliminating the discontinuous gradient caused by the truncated data in the previous frame, thereby effectively enhancing the image quality as well as increasing product competitiveness.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing apparatus, comprising:
a memory, for storing a data-truncated previous frame;
a processing unit, for performing an image smoothing process on the previous frame; and
an overdriving unit, for generating an output frame by an overdriving process according to the processed previous frame and a current frame.

2. The apparatus according to claim 1, wherein the processing unit comprises:
an edge detecting unit, for performing an edge detection on a target block in a plurality of blocks of the previous frame to generate an edge detection result;
a coefficient selecting unit, for determining a set of filter coefficients according to the edge detection result; and
a low-pass filter, for performing the image smoothing process on the target block according to the set of filter coefficients.

3. The apparatus according to claim 2, wherein the coefficient selecting unit determines a pixel value distribution of the target block according to the edge detection result, and determines a filter interval from the target block and the set of filter coefficients.

4. The apparatus according to claim 3, wherein the coefficient selecting unit determines whether the pixel value distribution is monotonically increasing.

5. The apparatus according to claim 3, wherein the coefficient selecting unit determines whether the pixel value distribution is monotonically decreasing.

6. The apparatus according to claim 2, wherein the edge detection determines whether a neighboring pixel difference is greater than a threshold, the neighboring pixel difference corresponds to an edge of the previous frame when the neighboring pixel difference is greater than the threshold, and the threshold corresponds to a least significant bit of the previous frame.

7. The apparatus according to claim 1, wherein a sum of the set of filter coefficients corresponds to a bit count of truncated data of the previous frame.

8. The apparatus according to claim 1, wherein the processed previous frame processed by the processing unit has a same bit count as that of the current frame.

9. An image processing method, applied to an image processing apparatus, comprising:
storing a data-truncated previous frame into a memory;
performing an image smoothing process on the previous frame; and
generating an output frame by an overdriving process according to the processed previous frame and a current frame.

10. The method according to claim 9, wherein the step of performing the image smoothing process on the previous frame comprises:
performing an edge detection on a target block in a plurality of blocks of the previous frame to generate an edge detection result;
determining a set of filter coefficients according to the edge detection result; and
performing the image smoothing process on the target block according to the set of filter coefficients.

11. The method according to claim 10, wherein the step of determining the set of filter coefficients determines a pixel value distribution of the target block according to the edge detection result, and determines a filter interval from the target block and the set of filter coefficients.

12. The method according to claim 11, wherein the step of determining the set of filter coefficients determines whether the pixel value distribution is monotonically increasing.

13. The method according to claim 11, wherein the step of determining the set of filter coefficients determines whether the pixel value distribution is monotonically decreasing.

14. The method according to claim 10, wherein the edge detection determines whether a neighboring pixel difference is greater than a threshold, the neighboring pixel difference corresponds to an edge of the previous frame when the neighboring pixel difference is greater than the threshold, and the threshold corresponds to a least significant bit of the previous frame.

15. The method according to claim 10, wherein a sum of the set of filter coefficients corresponds to a bit count of truncated data of the previous frame.

16. The method according to claim 9, wherein the previous frame processed by the processing unit has a same bit count as that of the current frame.
